(19) United States
(12) Patent Application Publication
(10) Pub. No.: US 2010/0316822 A1
(43) Pub. Date: Dec. 16, 2010

(54) TEXTILE SLEEVE WITH HIGH TEMPERATURE ABRASION RESISTANT COATING AND METHODS OF ASSEMBLY, CONSTRUCTION AND CURING THEREOF

(76) Inventor: Cassie M. Malloy, Blue Bell, PA (US)

Correspondence Address: ROBERT L. STEARNS;Dickinson Wright PLLC, 38525 Woodward Avenue, Ste. 2000, Bloomfield Hills, MI, 48304-2970, US

(21) Appl. No.: 12/814,685

(22) Filed: Jun. 14, 2010

Related U.S. Application Data
(60) Provisional application No. 61/186,606, filed on Jun. 12, 2009.

(51) Int. Cl. B32B 1/08; B05D 3/02

(52) U.S. Cl. 428/36.1; 427/389.9

(57) ABSTRACT

A textile sleeve for protecting elongate members with a high temperature abrasion resistant coating and methods of assembly, construction and curing thereof is provided. The textile sleeve includes a tubular textile wall formed of non-heatsettable yarn with interstices formed between adjacent filaments of the yarn. The wall has an outer surface and an inner surface providing an inner cavity for receipt of the elongate members. A fluoropolymer-based coating having about an 80 wt % fluoropolymer content is applied to the wall outer surface. The coating is substantially absorbed within the outer surface with the interstices being preserved. The coating is dried to an uncured state, and then subsequently cured at about 700 degrees Fahrenheit or greater. Upon being exposed and cured at a temperature of about 700 degrees Fahrenheit or more, the fluoropolymer-based coating melts and cross-links, thereby providing enhanced abrasion resistance protection to the wall.

### CROSS-REFERENCE TO RELATED APPLICATION

This application claims the benefit of U.S. Provisional Application Ser. No. 61/186,606, filed Jun. 12, 2009, which is incorporated herein by reference in its entirety.

### BACKGROUND OF THE INVENTION

1. Technical Field

This invention relates generally to textile sleeves for protecting elongate members, and more particularly to high temperature textile sleeves.

2. Related Art

Tubular sleeves are known for use to protect and provide a barrier to heat radiation from elongate members, such as an exhaust pipe, for example. By blocking the heat from radiating outwardly from the heat source, nearby components, e.g. wire harnesses, sensors, and the like, are protected against damage from the radiant heat. The sleeves are commonly constructed from heat resistant and/or fire retardant yarns to withstand relatively high temperatures. Sometimes the sleeves are constructed having multiple layers to facilitate block the heat from radiating outwardly. Although these sleeve are generally effective during initial use, they are commonly prone to damage from external environmental elements, e.g. stones and debris from the road/terrain surface. Further complicating matters the tendency for the heat resistant and/or fire retardant yarns to be prone to damage from abrasion.

A sleeve manufactured in accordance with the invention overcomes or greatly minimizes the tendency of a high temperature, textile sleeve from becoming damaged, such as from abrasive elements.

### SUMMARY OF THE INVENTION

A textile sleeve is provided for protecting elongate members. The textile sleeve includes a tubular textile wall formed entirely of non-heatsettable yarn with interstices formed between adjacent filaments of the yarn. The wall has an outer surface and an inner surface providing an inner cavity for receipt of the elongate members. A fluoropolymer-based coating having about an 80 wt % fluoropolymer content is applied to the wall outer surface. The coating is substantially absorbed by the outer surface with the interstices being preserved, wherein the interstices allow the sleeve to retain an increased degree of flexibility and stretch. The coating cures at about 700 degrees F. or greater, and thus, upon being exposed to a temperature of about 700 degrees Fahrenheit or more, the fluoropolymer melts and cross-links, thereby providing enhanced abrasion resistance protection to the wall.

In accordance with another aspect of the invention, a method of assembling a textile sleeve about a heat radiating elongate member is provided. The method includes providing the sleeve having a textile wall constructed entirely of yarns formed of high temperature materials capable of withstanding temperatures of 1000 degrees Fahrenheit or more. Further, the method includes providing the wall having an outer surface and an inner surface forming an enclosed tubular cavity with interstices extending between the inner and outer surfaces. The method further includes applying and drying a coating comprising 80 wt % or greater of a fluoropolymer on the outer surface of the wall with the fluoropolymer remaining in a less than fully cured state. Then, the method further includes disposing the inner surface over the elongate member, and then, upon being fully disposed on the elongate member, the method includes heating the coating to a temperature of about 700 degrees Fahrenheit or more, whereupon, the fluoropolymer melts and cross-links to a fully or substantially fully cured state, thereby providing enhanced protection to the multifilament yarns from external abrasive elements.

In accordance with another aspect of the invention, a method of constructing a textile sleeve for protecting elongate members is provided. The method includes forming a tubular textile wall formed entirely of non-heatsettable yarn with interstices formed between adjacent filaments of the yarn and having an outer surface and an inner surface providing an inner cavity for receipt of the elongate members. Then, applying a fluoropolymer-based coating having about an 80 wt % fluoropolymer content on the outer surface and allowing the coating to be absorbed by the yarn with the interstices being preserved. Further, drying the coating without curing the coating, and then, curing the coating after the drying step at about 700 degrees F. or greater to increase the abrasion resistance of the outer surface.

### BRIEF DESCRIPTION OF THE DRAWINGS

These and other aspects, features and advantages of the invention will become readily apparent to those skilled in the art in view of the following detailed description of the presently preferred embodiments and best mode, appended claims, and accompanying drawings, in which:

FIG. 1 is a perspective view of a textile sleeve constructed in accordance with one presently preferred embodiment of the invention shown disposed about a heat generating pipe;

FIG. 2 is a perspective side view of the sleeve showing an inner and outer wall of the sleeve with the inner wall unfolded in an extended position axially outwardly from the outer wall; and

FIG. 3 is a view similar to FIG. 2 with the inner wall reverse folded inside the outer wall.

### DETAILED DESCRIPTION OF PREFERRED EMBODIMENTS

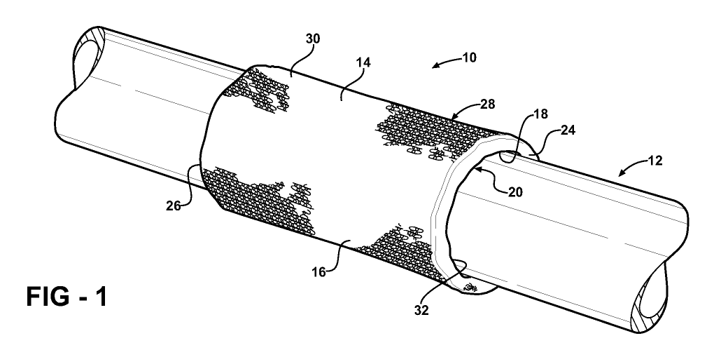

Referring in more detail to the drawings, FIGS. 1-3 show a tubular textile sleeve 10 constructed according to one embodiment of the invention. The sleeve 10 protects and provides a circumferential barrier to radiant heat, thereby providing protection to elongate members within the sleeve, or to components external to the sleeve 10 should the sleeve 10 be used to surround a source of radiant heat, such as an exhaust pipe 12, for example. By blocking the heat from radiating outwardly from the exhaust pipe 12, any nearby components, e.g. wire harnesses, sensors, and other heat sensitive components (not shown), are protected against damage from radiant heat. The textile sleeve 10 has a plurality of yarns interlaced with one another to form a wall 14, wherein the wall 14 can be formed to provide a closed (circumferentially continuous wall) or open tubular wall (having overlapping opposite edges extending generally parallel to a longitudinal axis 22 of the sleeve 10). The wall 14 has an outer most surface 16 and an inner most surface 18 defining a cavity 20 extending axially along the longitudinal axis 22 between opposite ends 24, 26 of the sleeve 10. The outer surface 16 of the wall 14 has a coating 28 comprising substantially 80 wt % or more of a fluoropolymer, while the fluoropolymer is in a dry state. The coating 28 is believed most affective if applied in a minimum of about 20 wt % of the outer layer of the sleeve 10. In addition to the fluoropolymer ingredient, some additives can be used increase durability and flexibility of the sleeve 10 as the temperature increases. It is believed that one having ordinary skill, in view of this disclosure and the desired sleeve properties described herein, would be able to derive a variety of different coatings 28 having at least 80 wt % fluoropolymer that would result in a suitable embodiment of the coating 28 to arrive at the desired functional sleeve properties discussed herein. The fluoropolymer-based coating 28 is applied and dried on the outer surface 16 to a state that is uncured, or at least less than fully cured, and upon being exposed to a temperature of about 700 degrees Fahrenheit or more, such as during use, the fluoropolymer within the coating 28 at least partially melts and cross-links to a fully or substantially full cured state, thereby providing enhanced protection to the multifilament yarns from external abrasive elements, such as stones and debris from the ground surface. It is desirable that the coating 28 not form an impervious skin or layer over the multifilament yarns forming the wall 14. By not forming a continuous film layer, and by only absorbing into or encapsulating the yarns individually over which the coating 28 is applied, thereby leaving interstices between adjacent yarns, the yarns are able to retain their flexibility and stretch characteristics as interlaced as long as the coating 28 remains uncured or substantially uncured, whether it be knitted, woven, braided, or otherwise interlaced. Accordingly, as long as the coating 28 is not subjected to temperature of about 700 degrees Fahrenheit or more, the outermost surface 16, and thus, the sleeve 10, retains its full or substantially full flexibility and stretch characteristics as originally interlaced.

The wall 14 can be constructed using any suitable method of construction, such as knitting, weaving or braiding, or non-woven materials, for example, wherein the type of respective patterns and/or stitches can be varied, as desired for the intended application. Further, the wall 14 can be constructed of any suitable length and diameter. Accordingly, the wall 14 can be constructed having various structural properties and configurations. For example, although the wall 14 is represented as having a reversed folded configuration in the figures, it could just a well be constructed as a single layer wall 14, if desired. The wall 14, in one presently preferred construction, can be constructed at least in part from a heat resistant material suitable for withstanding high temperature environments ranging from between about −60 to 1400 degrees centigrade. Some of the selected multifilament yarns are formed with mineral fiber materials, such as silica, fiberglass, ceramic, basalt, aramid or carbon, by way of example and without limitation. The mineral fibers can be provided having a continuous or chopped fiber structure. In some applications of extreme heat, it may be desirable to heat treat the sleeve material to remove organic content therefrom, thereby increasing the heat resistance capacity of the sleeve 10.

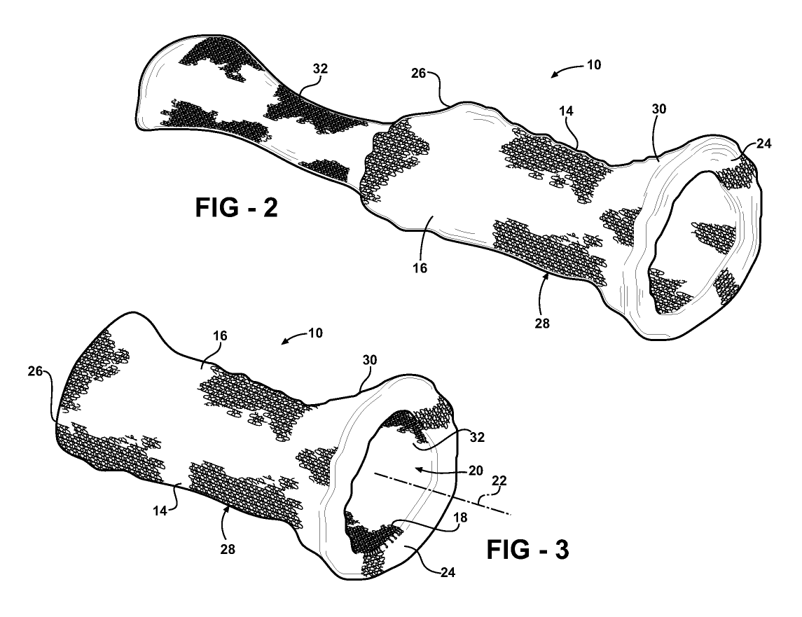

As best shown in FIG. 2, the sleeve 10 is represented here, for example, as having an outer wall 30 and an inner wall 32, wherein the outer and inner walls 30, 32 are attached together as one piece of continuous material. The inner wall 32 is reverse foldable for receipt within the outer wall 30 such the sleeve 10 has a dual wall finished construction. Both walls 30, 32 can be constructed from the same type of multifilament yarn, or they can be constructed using different types of yarn to provide the walls 30, 32 with different functional characteristics. Accordingly, the outer wall 30 can be constructed to meet one performance criteria, while the inner wall 32 can be constructed to achieve a different performance criteria.

In the dual wall sleeve 10 illustrated, the inner wall 32 can remain free or substantially free from the coating 28, and thus, the ability of the multifilaments used to construct the inner wall 32 to absorb heat is maximized. As such, the inner wall 32 is able to act as a heat shield to the outer wall 30, thereby keeping the outer wall 30 from reaching the same extreme, high temperature as the inner wall 32. Although it is desirable for the outer wall 30 to reach temperatures above 700 degrees F. to fully cure the fluoropolymer-based coating 28, if the outer wall 30 temperature is sustained at temperatures above about 1000 degrees F. in use, the chemistry of the coating 28 can be negatively impacted on a microscopic level. Accordingly, although believed desirable to allow the outer wall 30 to reach temperatures above 700 degrees F., it is also believed desirable to prevent the outer wall 30 from being maintained at temperatures above about 1000 degrees F. on a continuous basis. As such, although the inner wall 32 may function comfortably at temperatures above 1000 degrees F. in use, the ability of the inner wall 32 to shield the outer wall 30 against some radiant heat is beneficial to maximizing the useful life of the sleeve 10.

The outer wall 30 can be entirely coated with the coating 28, such as by dipping, spraying, painting, or otherwise. Upon the coating 28 being applied, the coating 28 is dried, and can be allowed to dry naturally without assistance of a heat source, or heat can be applied, such as between about 100-200 degrees F. If the sleeve 10 is preferred to retain full flexibility, it is preferable to heat the coating 28 sufficiently to dry the coating 28, however, not sufficiently to fully cure the coating 28. Upon drying the coating 28 on the outer wall 30, the inner wall 32 can be reversed folded therein. At this time, the sleeve 10 is ready for use, and thus, can be disposed over the exhaust pipe 12, whereupon the coating 28 can be subsequently cured by the heat applied while in use. Optionally, however, upon drying the coating 28, the coating 28 can be heated to 700 degrees F. or higher and thus, cured prior to disposing the sleeve 10 on the pipe 12 should it not be necessary to flex or otherwise stretch the outer wall 30 during assembly.

In use, the inner wall 32 can reach temperatures well in excess of 1000 degrees F., while the outer wall is preferably heated above 700 degrees F. for at least about 10 minutes, whereupon the fluoropolymer is at least partially melted and substantially or fully cured. As such, fluoropolymer-based coating 28, upon being cured, is able to provide enhanced protection to the uncoated inner wall 32 against abrasion from debris that may impact the outermost surface 16 of the outer wall 30. Accordingly, the useful life of the sleeve 10 is increased by preventing the outer wall 30, and thus, the inner wall 32 from being abraded.

It should be recognized that sleeve assemblies 10 constructed in accordance with the invention are suitable for use in a variety of applications, regardless of the sizes and lengths required. For example, they could be used in automotive, marine, industrial, aeronautical or aerospace applications, or any other application wherein protective sleeves are desired to protect nearby components against heat radiation.

It is to be understood that the above detailed description is with regard to some presently preferred embodiments, and that other embodiments readily discernible from the disclosure herein by those having ordinary skill in the art are incorporated herein and considered to be within the scope of any ultimately allowed claims.

What is claimed is:

1. A textile sleeve for providing protection to elongate members, comprising:
a tubular textile wall formed entirely of non-heatsettable yarn with interstices formed between adjacent filaments of said yarn, said wall having an outer surface and an inner surface providing an inner cavity for receipt of the elongate members; and
a fluoropolymer-based coating having about an 80 wt % fluoropolymer content applied to said outer surface, said coating being substantially absorbed by said outer surface with said interstices being preserved, said coating curing at about 700 degrees Fahrenheit or greater.

2. The textile sleeve of claim 1 wherein said non-heatsettable yarn has a minimum temperature rating of 700 degrees Fahrenheit.

3. The textile sleeve of claim 2 wherein said non-heatsettable yarn includes at least one mineral fiber selected from a group consisting of: fiberglass, basalt, ceramic, aramid, carbon and silica.

4. The textile sleeve of claim 1 wherein said non-heatsettable yarn is a multifilament.

5. The textile sleeve of claim 1 wherein said wall is reverse folded providing separate outer and inner wall layers, said outer wall layer providing said outer surface and said inner wall layer providing said inner surface.

6. The textile sleeve of claim 5 wherein said inner wall layer is substantially free of said fluoropolymer-based coating.

7. A method of assembling a textile sleeve about a heat radiating elongate member and curing an abrasion resistant coating on an outer surface of the sleeve, comprising:
forming a textile wall having an outer surface and an inner surface;
applying a fluoropolymer-based coating on the outer surface;
drying the coating to a less than fully cured state;
disposing the wall of the sleeve while in its less than fully cured state about heat radiating elongate member; and
curing the coating at a temperature of about 700 degrees Fahrenheit or greater after disposing the sleeve on the heat radiating elongate member.

8. The method of claim 7 further including curing the coating with heat radiated by the elongate member.

9. The method of claim 7 further including providing the fluoropolymer-based coating having at least 80 wt % fluoropolymer content.

10. The method of claim 7 further including providing the wall having reverse folded outer and inner wall layers with the outer wall layer providing the outer surface and the inner wall layer providing the inner surface.

11. The method of claim 10 further including providing the inner wall layer being substantially free of the fluoropolymer-based coating.

12. A method of constructing a textile sleeve and curing a coating thereon, comprising:
forming a tubular textile wall formed entirely of non-heatsettable yarn with interstices formed between adjacent filaments of the yarn and having an outer surface and an inner surface providing an inner cavity for receipt of the elongate members;
applying a fluoropolymer-based coating having about an 80 wt % fluoropolymer content on the outer surface and allowing the coating to be absorbed by the yarn with the interstices being preserved;
drying the coating without curing the coating; and
curing the coating after the drying step at about 700 degrees Fahrenheit or greater to increase the abrasion resistance of the outer surface.

13. The method of claim 12 further including providing the non-heatsettable yarn having a minimum temperature rating of 700 degrees Fahrenheit.

14. The method of claim 13 further including providing the non-heatsettable yarn from at least one mineral fiber selected from a group consisting of: fiberglass, basalt, ceramic, aramid, carbon and silica.

15. The method of claim 12 further including providing the non-heatsettable yarn as a multifilament.

16. The method of claim 12 further including reversed folding the wall and providing separate outer and inner wall layers with the outer wall layer providing the outer surface and the inner wall layer providing the inner surface.

17. The method of claim 16 further including leaving the inner wall layer substantially free of the fluoropolymer-based coating.
